(19) United States
(12) Patent Application Publication
(10) Pub. No.: US 2025/0219158 A1
(43) Pub. Date: Jul. 3, 2025

(54) AQUEOUS ZINC-ION BATTERY WITH STABLE PERFORMANCE DURING OVERCHARGING

(71) Applicant: City University of Hong Kong, Hong Kong (HK)

(72) Inventors: Chunyi ZHI, Hong Kong (HK); Shuo YANG, Hong Kong (HK)

(21) Appl. No.: 18/399,743

(22) Filed: Dec. 29, 2023

(51) Int. Cl. H01M 10/42; H01M 4/50; H01M 10/36; H01M 10/44

(52) U.S. Cl. CPC H01M 10/4235; H01M 4/50; H01M 10/36; H01M 10/44; H01M 2300/0002; H01M 2300/0085

(57) ABSTRACT

The present invention provides bromine-based additives for overcharge protection in aqueous zinc-ion batteries. These additives undergo oxidation before electrolyte decomposition during overcharging, effectively preventing overcharge. As a result, the batteries demonstrate significantly extended lifespans and maintain stable electrolyte environments. The overcharge protection is effective for more than 650 hours in Zn∥MnO₂ batteries and 500 hours in Zn∥MnVO batteries.

### FIELD OF THE INVENTION

The present invention generally relates to the field of battery technology, specifically addressing issues related to zinc-ion batteries (ZIBs), focusing on their safety, stability, and protection against overcharging.

### BACKGROUND OF THE INVENTION

The utilization of aqueous electrolytes in zinc-ion batteries (ZIBs) offers significant safety advantages compared to the organic-based counterparts, such as lithium-ion batteries (LIBs) and sodium-ion batteries (SIBs). Recent efforts have focused on the development of high-performance electrode materials with long-term stability, aiming to enhance the overall stability and reliability of aqueous ZIBs¹⁻³. However, the vulnerability of ZIBs to malfunction and safety concerns under abuse conditions have been largely overlooked. Overcharge, a typical improper operation in LIBs, poses a significant safety and reliability risk to aqueous batteries as well^{4, 5}. Although the risk of thermal runaway is absent in aqueous batteries, electrolyte decomposition and exacerbated dendrite formation at the overcharge state may deteriorate the performance of the batteries⁶. Besides, excessive gas generation during this process can lead to battery swelling, diminished interfacial contact, and even potential explosion⁷.

In emerging ZIBs using neutral electrolytes, gas generation during overcharge would be more severe than those with highly acidic and alkaline electrolytes, as the latter benefit from an “oxygen cycle” that mitigates water decomposition in the electrolyte⁶. Furthermore, the stability of cathode materials in neutral electrolytes during overcharging may be compromised, ultimately resulting in capacity decay in batteries⁸. Therefore, it is crucial to conduct a comprehensive investigation into the evolution of batteries during the overcharge process and develop effective strategies to protect batteries from overcharging.

### SUMMARY OF THE INVENTION

Accordingly, the present invention aims to address safety and reliability concerns of ZIBs, particularly under improper operating conditions, such as overcharging, and explores methods to improve electrolyte stability and prevent issues arising from overcharging.

This present invention investigates the electrochemical behavior and evolution of aqueous ZIBs by selecting Mn²⁺ expanded hydrated vanadium (MnVO) and manganese dioxide (MnO₂) as cathode materials. Experimental findings highlight the detrimental effects of overcharging on ZIBs, leading to rapid battery failure primarily attributed to electrolyte decomposition and subsequent deterioration of interfacial contact. The observed improved stability in Zn∥MnO₂ batteries at the overcharge state, attributed to Mn²⁺ deposition from the electrolyte, indicates the potential of incorporating an additional redox couple in the electrolyte to effectively alleviate issues arising from overcharging. As a result, self-sacrificial electrolytes are developed by introducing bromine-based additives into the electrolyte. These additives undergo oxidation before electrolyte decomposition, thereby offering protection against overcharging. Consequently, the batteries exhibit significantly prolonged lifespans and maintain stable electrolyte environments during overcharging.

In a first aspect, the present invention provides an aqueous battery system with stable performance during overcharging, which includes an electrolyte and a self-sacrificial additive. The self-sacrificial additive is incorporated into the electrolyte to provide long-term overcharge protection. The aqueous battery system demonstrates an enhanced cycling stability even at harsh conditions of 200% state-of-charge (SOC), providing overcharge protection for a duration ranging from 500-700 hours.

In one of the embodiments, the aqueous battery system has one or more electrodes, wherein the self-sacrificial additive is impregnated in or coated on the electrodes, the self-sacrificial additive undergoes oxidation before electrolyte decomposition, thereby offering protection against overcharging. The one or more electrodes include Mn²⁺ expanded hydrated vanadium (MnVO) and manganese dioxide (MnO₂).

In one of the embodiments, the electrolyte includes a gel polymer electrolyte, wherein the self-sacrificial additive is incorporated into the gel polymer electrolyte.

In one of the embodiments, the self-sacrificial additive includes bromide-based additive in a concentration range of 0.1 M to 2.0 M. The bromide-based additive is selected from organic bromides or bromide salts. The organic bromides include alkyl bromide, brominated ether, brominated esters, and brominated aromatics, and the bromide salts include bromide of alkali or alkaline earth metals.

In another embodiments, the aqueous battery system further includes a complexing agent, including tetrabutylammonium (TBA+) and benzyl trimethylammonium cation (BTA⁺).

In a second aspect, the present invention also provides a method for protecting against overcharge in an aqueous battery system. The method involves adding a self-sacrificial additive to the battery system. The self-sacrificial additive reacts during charging to prevent overcharging.

In one of the embodiments, the self-sacrificial additive is added to an electrolyte in a concentration range effective for overcharge protection.

In one of the embodiments, the electrolyte includes a gel polymer electrolyte, wherein the self-sacrificial additive is incorporated into the gel polymer electrolyte.

In one of the embodiments, the self-sacrificial additive includes a bromide-based additive, the bromide-based additive undergoes reversible redox reactions during charging and discharging, thereby preventing overcharge-induced degradation.

In one of the embodiments, the method further including monitoring the battery system's voltage, current, or other relevant parameters to control the charge-discharge process and ensure optimal overcharge protection.

Compared to the existing technology, the present inventions offer significant advantages, which include:
(1) Addressing the absence of additives for overcharge protection in aqueous batteries;
(2) The invention offers a straightforward and easily implemented preparation process, ensuring ease of integration into existing manufacturing procedures for aqueous batteries;
(3) The electrolyte formulation, which incorporates the additive, can be readily scaled up to facilitate large-scale production, ensuring a consistent and dependable electrolyte supply for manufacturers of aqueous batteries.

### BRIEF DESCRIPTION OF THE DRAWINGS

Embodiments of the invention are described in more details hereinafter with reference to the drawings, in which:

FIG. 1A shows XRD pattern of the as-prepared MnVO. FIG. 1B and FIG. 1C show SEM images of MnVO showing the aggregation of nanosheets into a micro-flower-like morphology;

FIG. 2A shows XRD pattern of the as-prepared MnO₂. FIG. 2B and FIG. 2C show SEM images of MnO₂ exhibiting an irregular hexagonal nanoplate morphology;

FIG. 3A shows CV curves of Zn∥MnVO batteries under different operating voltage windows with a scan rate of 2 mV s⁻¹. FIG. 3B shows GCD curves of Zn∥MnVO batteries cycling at 150% and 200% SOC. FIG. 3C shows cycling performance of Zn∥MnVO batteries operating at different conditions;

FIG. 4 shows GCD curves of Zn∥MnVO batteries cycling at normal operation;

FIG. 5A shows GCD curves of Zn∥MnVO batteries cycling at 150% SOC. FIG. 5B shows GCD curves of Zn∥MnVO batteries cycling at 200% SOC;

FIG. 6 shows EIS curves of Zn∥MnVO batteries cycling at 200% SOC;

FIG. 7 shows CV curves of Zn∥MnO₂ batteries under different operating voltage windows with a scan rate of 2 mV s⁻¹;

FIG. 8 shows GCD curves of Zn∥MnO₂ batteries cycling at 150% and 200% SOC;

FIG. 9 shows cycling performance of Zn∥MnO₂ batteries operating at different conditions;

FIG. 10A shows GCD curves of Zn∥MnO₂ batteries cycling at 150% SOC. FIG. 10B shows GCD curves of Zn∥MnO₂ batteries cycling at 200% SOC;

FIG. 11 shows GCD curves of Zn∥MnO₂ batteries cycling at normal operation;

FIG. 12 shows EIS curves of Zn∥MnO₂ batteries cycling at 200% SOC;

FIG. 13A shows Operando pressure measurement to monitor gas production in Zn∥MnVO batteries. FIG. 13B shows GC measurement of H₂ and O₂ generation at different stages for Zn∥MnVO batteries. FIG. 13C shows Operando pressure measurement to monitor gas production in Zn∥MnO₂ batteries. FIG. 13D shows GC measurement of H₂ generation at different stages for Zn∥MnO₂ batteries. FIG. 13E shows GC measurement of O₂ generation at different stages for Zn∥MnO₂ batteries;

FIG. 14 shows In-situ optical microscope images demonstrating the gas generation at the electrode surface;

FIG. 15A shows the evolution of pH values of MnVO and substrate recorded for Zn∥MnVO batteries at different charge-discharge processes with a current density of 0.5 A g⁻¹. FIG. 15B shows the evolution of pH values of MnO₂ and substrate recorded for Zn∥MnO₂ batteries at different charge-discharge processes with a current density of 0.5 A g⁻¹. FIG. 15C shows the evolution of V concentration in the electrolyte of MnVO and substrate recorded for Zn∥MnVO batteries at different charge-discharge processes with a current density of 0.5 A g⁻¹;

FIG. 16A shows the XRD pattern of MnVO electrode cycling at normal operation.

FIG. 16B shows XRD pattern of MnVO electrode cycling at normal operation at 200% SOC.

FIG. 16C shows the evolution of peak intensity ratio of MnVO and substrate recorded for Zn∥MnVO batteries at different charge-discharge processes with a current density of 0.5 A g⁻¹;

FIG. 17A shows the evolution of Mn concentration in the electrolyte of Zn∥MnO₂ batteries at different charge-discharge processes with a current density of 0.5 A g⁻¹. FIG. 17B shows XRD pattern of MnO₂ electrode cycling at normal operation and 200% SOC. FIG. 17C shows peak intensity ratio of MnO₂ and substrate recorded for Zn∥MnO₂ batteries at different charge-discharge processes with a current density of 0.5 A g⁻¹;

FIG. 18 shows SEM images of Zn anode at the initial state, after cycling at normal operations and 200% SOC for 10 cycles in Zn∥MnVO batteries;

FIG. 19 shows SEM images of Zn anode at the initial state, after cycling at normal operations and 200% SOC for 10 cycles in Zn∥MnO₂ batteries;

FIG. 20A shows electrostatic potential on van der Waals surfaces of TBA⁺ and BTA⁺. FIG. 20B shows the calculated adsorption energy of TBA⁺ and BTA⁺ to various Br species (Br⁻, Br₂, and Br₃⁻);

FIG. 21 shows voltage-time curves of Zn∥MnVO batteries with BTABr additive in the electrolyte;

FIG. 22 shows CV curves of MnVO and TBABr at a scan rate of 2 mV s⁻¹;

FIG. 23 shows CV curves of Zn∥MnVO batteries with and without TBABr additive at a scan rate of 2 mV s⁻¹;

FIG. 24 shows SEM images of MnVO electrode at initial state and 200% SOC;

FIG. 25 shows Br 3d XPS spectra of MnVO electrode at the initial state and 200% SOC;

FIG. 26A shows GCD curves of Zn∥MnVO batteries with and without TBABr additive at normal operation. FIG. 26B shows cycling performance of Zn∥MnVO batteries with TBABr additive at normal operation;

FIG. 27A shows the cycling performance of Zn∥MnVO batteries with TBABr additive operating at 200% SOC. FIG. 27B shows corresponding voltage-time curves of Zn∥Mn VO batteries with TBABr additive operating at 200% SOC;

FIG. 28A and FIG. 28B show EIS curves and gas production of Zn∥MnVO batteries with TBABr additive cycling at 200% SOC;

FIG. 29 shows a comparation of pH values in the electrolytes with and without TBABr additive at different states;

FIG. 30A shows GCD curves of Zn∥MnO₂ batteries with and without TBABr additive at 200% SOC. FIG. 30B shows voltage-time curves of Zn∥MnO₂ batteries with TBABr additive cycling at 200% SOC;

FIG. 31A shows CV curves of Zn∥MnO₂ batteries with and without BTABr additive at a scan rate of 2 mV s⁻¹. FIG. 31B shows SEM images of MnO₂ electrode at the initial state and 200% SOC;

FIG. 32A shows GCD curves of Zn∥MnO₂ batteries with and without BTABr additive at normal operation. FIG. 32B shows cycling performance of Zn∥MnO batteries with BTABr additive at normal operation;

FIG. 33A and FIG. 33B show cycling performance of Zn∥MnO₂ batteries with BTABr additive operating at 200% SOC and the corresponding voltage-time curves, respectively. FIG. 33C shows EIS curves of Zn∥MnO₂ batteries with BTABr additive cycling at 200% SOC. FIG. 33D shows gas production of Zn∥MnO₂ batteries with BTABr additive cycling at 200% SOC. FIG. 33E shows a comparation of pH values in the electrolytes with and without BTABr additive at different states.

### DETAILED DESCRIPTION

In the following description, Mn²⁺ expanded hydrated vanadium (MnVO) and manganese dioxide (MnO₂) as the representative cathode materials in ZIBs are set forth as preferred examples. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

Aqueous zinc-ion batteries (ZIBs) have attracted considerable attention due to their superior safety resulting from the use of non-flammable electrolytes. However, challenges related to malfunctions and safety issues persist, particularly in the context of overcharge conditions in ZIBs, which have been largely overlooked and received limited attention. Both Zn∥Mn VO and Zn∥MnO₂ systems experience reduced stability during overcharging, which can be attributed to deteriorating interfacial contact caused by electrolyte decomposition and gas generation within the batteries.

Accordingly, the present invention provides an aqueous battery system, such as Zn∥MnVO or Zn∥MnO₂ battery systems. Both of the systems have an electrolyte and a self-sacrificial additive. The self-sacrificial additive is incorporated into the electrolyte to provide long-term overcharge protection. The Zn∥MnVO or Zn∥MnO₂ batteries incorporating self-sacrificial additive exhibit significantly improved cycling stability even at harsh conditions of 200% state-of-charge (SOC), providing overcharge protection for approximately 650 hours and approximately 500 hours, respectively.

In order to protect batteries from potential safety issues and performance degradation under overcharge conditions, the redox additives are introduced into the electrolytes acting as self-sacrificial agents. During overcharging, the self-sacrificial additives can undergo oxidation reactions before electrolyte decomposition, effectively preventing electrolyte decomposition and shielding the battery from interior damage.

In one of the embodiments, the aqueous battery system can use Mn²⁺ expanded hydrated vanadium (MnVO) as cathode materials.

In another embodiments, the aqueous battery system can use manganese dioxide (MnO₂) as cathode materials.

For example, the Zn∥MnVO batteries exhibit relatively poor cycling stability when subjected to overcharging, while the supplementary Mn²⁺/MnO₂ redox reaction in Zn∥MnO₂ batteries helps mitigate the detrimental effects of overcharge evolution and improves the electrochemical performance of the batteries.

In one of the embodiments, the self-sacrificial agents may be bromine-based additives. Bromine (Br)-based additives based on the Br/Br₂ redox couple show electrochemical reversibility at higher potentials, approximately 1.08 V vs. SHE, surpassing the operating potentials of both MnVO and MnO₂ cathodes.

In one of the embodiments, the concentration of the self-sacrificial agents can be selected from organic bromides or bromide salts, which are in a range of 0.1 M to 2.0 M. For instance, the concentration can be 0.1 M, 0.5 M, 1 M, 1.5 M, or 2 M. Organic bromides may be alkyl bromide, brominated ether, brominated esters, and brominated aromatics. Bromide salts may be bromides of alkali or alkaline earth metals.

Incorporating bromine-based redox-active additives into the electrolyte not only provides an additional Br/Br₂ redox couple but also promotes the deposition of MnO₂ from the electrolyte in Zn∥MnO₂ batteries.

In one of the embodiments, the electrolyte may be a gel polymer electrolyte, such as polyacrylamide, sodium polyacrylate.

In one of the embodiments, the system further includes a complexing agent, such as tetrabutylammonium (TBA⁺) and benzyl trimethylammonium cation (BTA⁺). They are utilized as complexing agents to mitigate their oxidizing and corrosive issues associated with Br species.

In another aspect, the present invention also provides a method for protecting against overcharge in an aqueous battery system. The method is conducted by adding a self-sacrificial additive to the battery system described above. The self-sacrificial additive reacts during charging to prevent overcharging.

In summary, the present invention centers around the utilization of bromide compounds as additives for overcharge protection in aqueous batteries. Its primary objective is to thwart overcharge-induced damage to batteries by integrating bromide compounds into the electrolyte solution of aqueous batteries. Through this incorporation, the invention seeks to bolster the safety and lifespan of these batteries by alleviating the adverse consequences of overcharging. The broad applications of this innovation extend to diverse aqueous battery systems, encompassing electric vehicles, renewable energy storage, portable electronic devices, and large-scale energy storage systems.

### EXAMPLE

### Example 1

### Methods

### Preparation of Cathode

Mn²⁺ expanded hydrated V₂O₅ (MnVO) cathode material with a micro-flower-like shape was prepared according to a previous study.³¹ Specifically, 2 mmol of V₂O₅ was dissolved in a mixture of 50 mL H₂O and 2 mL H₂O₂, and separately dissolved 1 mmol of MnSO₄·4H₂O in 30 mL H₂O. The two solutions were then admixed and transferred to a 100 Teflon lined stainless steel autoclave, which was heated to and held at 120° C. for 6 h. Afterward, brick red precipitates were collected by centrifugation and washed three times with water and ethanol. Finally, the collected precipitates were dried at 70° C. overnight.

The synthesis of MnO₂ was conducted based on the previous work, with slight modifications.³² Initially, 3 ml of hydrazine hydrate solution was introduced into a 40 mL Mn(Ac)₂ solution with a concentration of 4 mmol L⁻¹, followed by 5 minutes of stirring. Subsequently, the solution was transferred to a 100 mL Teflon-lined stainless-steel autoclave and subjected to hydrothermal treatment at 180° C. for 12 hours. The Mn(OH)₂ was obtained by centrifugation and then freeze-dried at 60° C. under vacuum. After that, 0.2 g of Mn(OH)₂ was dispersed in 50 ml of water containing 10 mL of NaClO solution and reacted for 24 hours under stirring. The final MnO₂ nanoplates were collected after washing the black suspension and dried under a vacuum at 60° C. overnight.

To prepare the cathode, a slurry containing the active material, Ketjenblack, and poly(1,1-difluoroethylene) (PVDF) in a weight ratio of 70:20:10 was coated onto a carbon cloth, which was then dried under vacuum at 60° C. for 12 hours.

### Computational Details

The electrostatic potential (ESP) calculation was conducted using the DMol3 package. The structure optimization and calculations were described using the B3LYP hybrid functional, and the Grimme method was used for dispersion-corrected density functional theory calculations (DFT-D). DFT semicore pseudopotentials core treatment was implemented for relativistic effects, replacing core electrons with a single effective potential. Double numerical plus polarization was employed as the basis set. The convergence tolerance of energy of 10-6 Hartree was taken (1 Hartree=27.21 eV), and the maximal allowed force and displacement were 0.002 and 0.005 Hartree Å⁻¹, respectively.

### Example 2

### Appearance Characterizations

The crystal structure and phase composition were characterized by X-ray diffraction (XRD) using a Rigaku X-ray Diffractometer SmartLab™ 9 kW (Cu Kα, λ=0.154 nm). The micromorphology of products was investigated by scanning electron microscope (SEM, ESEM, FEI/Philips XL30). The X-ray Photoelectron Spectrometer (XPS) studies were performed using a PHI5000 VersaProbe II photoelectron spectrometer, and the spectra were calibrated using a carbon spectrum as a reference. Inductively coupled plasma-optical emission spectrometer (ICP-OES, Agilent ICPOES730) was used to monitor the evolution of electrolyte ions. The pH evolution of the electrolyte was monitored using a pH meter in batteries assembled in polystyrene cuvettes (10×10×45 mm) commonly used for UV-Vis spectroscopy measurements. The operando gas pressure measurement was performed using a gas pressure sensor connected to a sealed electrochemical cell. Before the tests, the cell was filled with Ar gas to replace the air. Based on the ideal gas law, the gas pressure (in kPa) was converted to the gas amount (in nmol). The in-situ GC measurement was performed on a gas chromatography system (GC 2060, Shanghai Ruimin Instruments Co., Ltd.) connected to a sealed electrochemical cell.

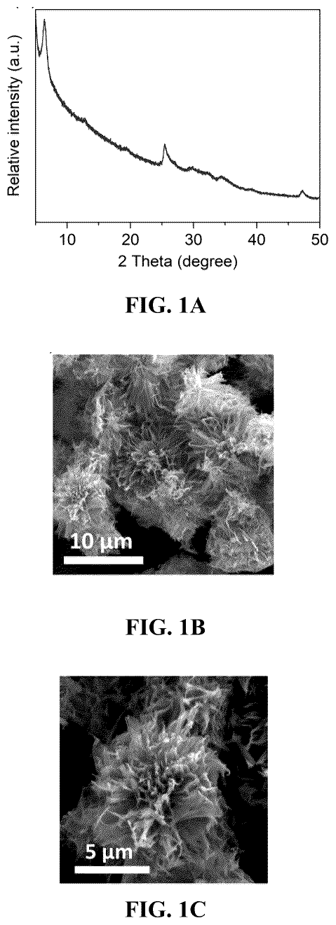

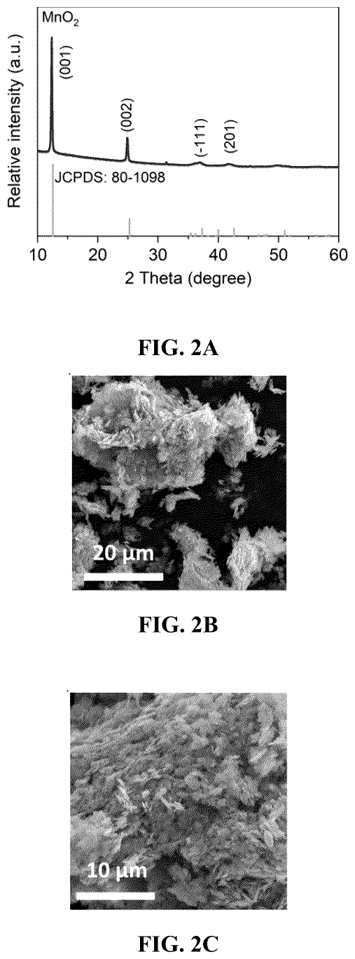

The crystal structure and micromorphology of the MnVO and MnO₂ were first investigated. The crystal structure and micromorphology of the MnVO were shown in FIGS. 1A-1C, and the crystal structure and micromorphology of the MnO₂ were shown in FIGS. 2A-2C. The as-prepared MnVO and MnO₂ display distinctive morphologies, with the former exhibiting a micro-flower-like structure and the latter showing hexagonal nanoplatelets. Notably, no obvious impurity peaks were detected by the X-ray diffraction (XRD) measurements, indicating the successful preparation of the cathode materials.

### Example 3

### Electrochemical Characterizations of Zn∥MnO₂ Batteries and Zn∥MnVO Batteries

All the batteries were assembled into CR-2032 coin cells, where bare Zn served as the anode, and a glass fiber separator (Waterman-1820) was utilized.

For Zn∥MnVO batteries, the electrolyte employed was 3 M zinc trifluoromethanesulfonate (ZnOTF). In order to protect the batteries from overcharging, tetrabutylammonium bromide (TBABr) was included in the electrolyte at a concentration of 0.4 mol L⁻¹.

For Zn∥MnO₂ batteries, the electrolyte consisted of 2 M ZnSO₄ and 0.2 M MnSO₄. Trimethylammonium bromide (BTABr) was added to the electrolyte at a concentration of 0.1 mol L⁻¹ to provide overcharge protection.

The electrochemical performance and the evolution of battery components were investigated under various operating conditions. The galvanostatic charging-discharging processes were conducted using the Land battery testing system (Wuhan, China) at different current densities. All the batteries were cycled at a current density of 0.5 A g⁻¹. In order to test the electrochemical performance under overcharging conditions, the batteries were first charged until reaching a specified capacity and then discharged to certain voltages. The cyclic voltammogram (CV) and electrochemical impedance spectroscopy (EIS) measurements were conducted using a CHI-760 electrochemical working station.

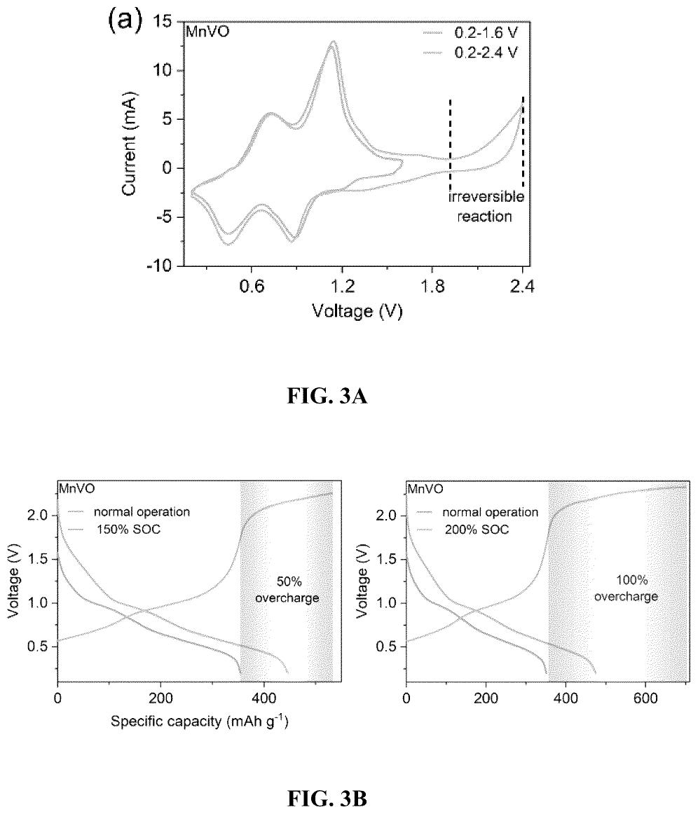

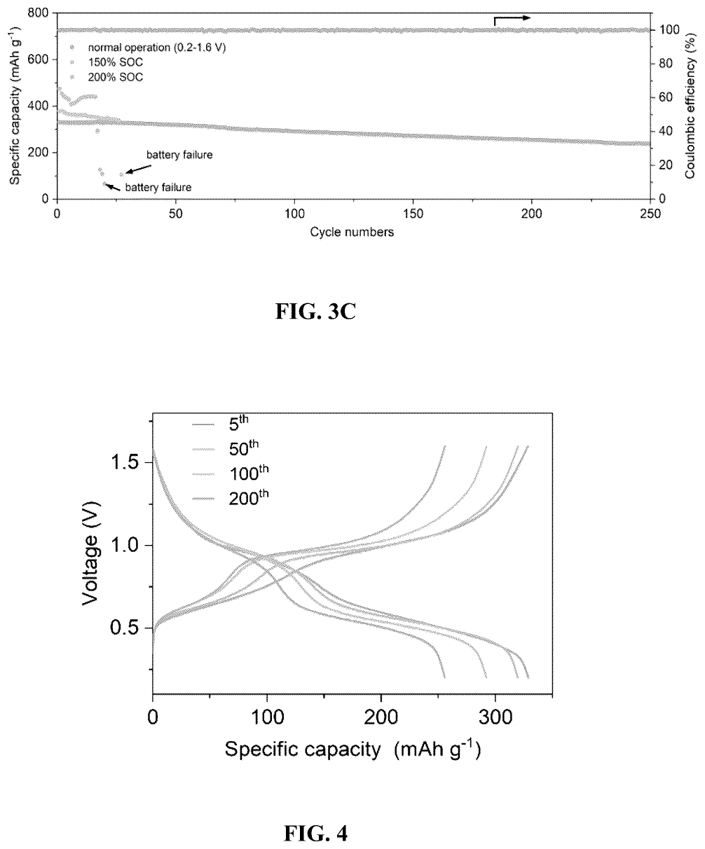

As shown in FIG. 3A, two pairs of reversible redox peaks could be observed in the cyclic voltammetry (CV) curves of Zn∥MnVO batteries within the operating voltage window of 0.2-1.6 V, corresponding to the redox reactions of V⁵⁺/V⁴⁺ and V⁴⁺/V³⁺, respectively¹². Within the voltage range of 0.2-2.4 V, a new cathodic peak emerged at approximately 2.0 V, while no corresponding anodic peak was observed. This phenomenon implied the presence of an irreversible electrochemical reaction at high potentials.

Additionally, the irreversible reaction at the overcharge state was also evident in the galvanostatic charge/discharge (GCD) curves. Referring to FIG. 3B, the Zn∥MnVO batteries delivered a specific capacity of approximately 350 mAh g⁻¹ at 0.5 A g⁻¹, with two distinct discharge plateaus located at 1.0 V and 0.5 V, which are consistent with the results derived from CV measurement. Subsequently, the batteries were charged until reaching the cut-off capacity of 525 mAh g⁻¹ for 150% SOC and 700 mAh g⁻¹ for 200% SOC. During the charging process, the battery voltage increased rapidly to 2.0 V after reaching 100% SOC, followed by a prolonged plateau. The plateau at 2.0 V was related to the irreversible reaction observed in the CV curves, which was attributed to electrolyte decomposition occurring during overcharging⁸. Moreover, the discharge capacities of Zn∥MnVO batteries increased with the SOC during charging, reaching 446 mAh g⁻¹ at 150% SOC and 475 mAh g⁻¹ at 200% SOC, respectively. However, the coulombic efficiencies (CEs) of the batteries decreased from 83.9% to 67.8% as the SOC increased, indicating a deterioration in reversibility. The cycling stability of Zn∥MnVO batteries under various operating conditions was intuitively compared in FIG. 3C. The battery cycled at normal operation exhibited superior stability, maintaining a stable capacity of approximately 240 mAh g⁻¹ after 250 cycles, accompanied by a relatively high-capacity retention of 68.6%.

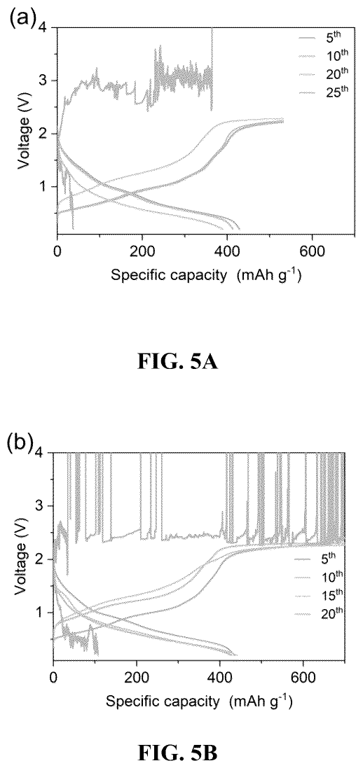

Turning to FIG. 4, it was noteworthy that in any GCD curve, two distinct discharge plateaus could be constantly observed, demonstrating the consistent electrochemical reactions throughout the entire cycling process. In contrast, Zn∥MnVO batteries cycled at 150% and 200% SOC exhibited significantly reduced lifespans, experiencing rapid failure at the 20^{th} and the 27^{th} cycle, respectively. The GCD curve corresponding to the occurrence of battery failure, as depicted in FIGS. 5A-5B, displayed notable voltage fluctuations. These fluctuations could be attributed to the failure of interfacial contact, which was primarily caused by electrolyte decomposition and gas generation¹³.

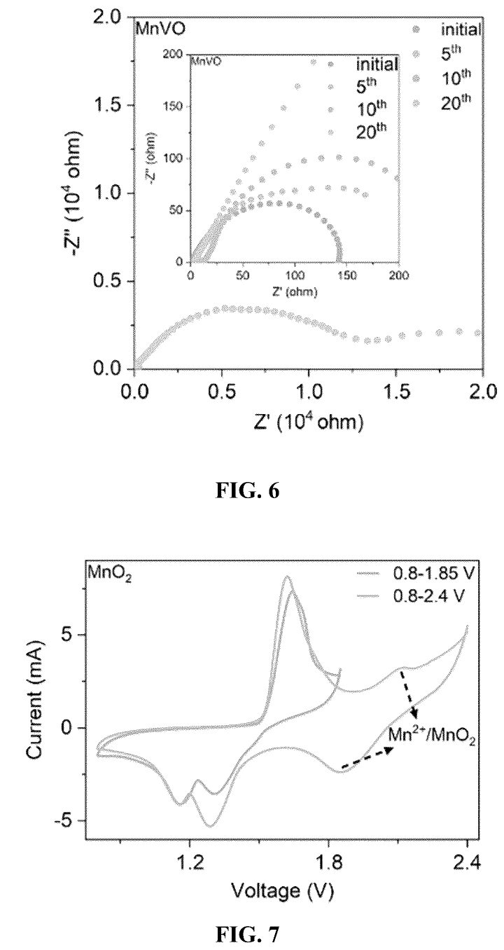

Furthermore, electrochemical impedance spectroscopy (EIS) was conducted at 200% SOC to assess the impedance characteristics of the batteries. As shown in FIG. 6, the EIS curves exhibited a distinctive semicircle pattern, where the diameter of the semicircle corresponds to the charge-transfer resistance, while the inclined line signifies the ion diffusion impedance¹⁴. At the initial several cycles, the charge-transfer resistance of the battery decreased due to the activation of the electrode materials. However, a significant increase in impedance was observed at the 20^{th} cycle, reaching a value of 10⁴Ω. This substantial impedance increase further supported the conclusion that the failure of batteries was primarily caused by the loss of interfacial contact and hindered charge transfer reactions.

The electrochemical behavior of Zn∥MnO₂ batteries at overcharge state exhibited distinct characteristics compared to Zn∥MnVO batteries. As shown in FIG. 7, two pairs of redox peaks could be observed in the CV curves within the voltage window of 0.8-1.85 V, corresponding to the de/intercalation of H⁺ and Zn²⁺ ions within the cathode materials¹⁵. Besides, an extra redox pair became apparent during the overcharge state, which was associated with the deposition of MnO₂ from the electrolyte onto the electrode surface¹⁶.

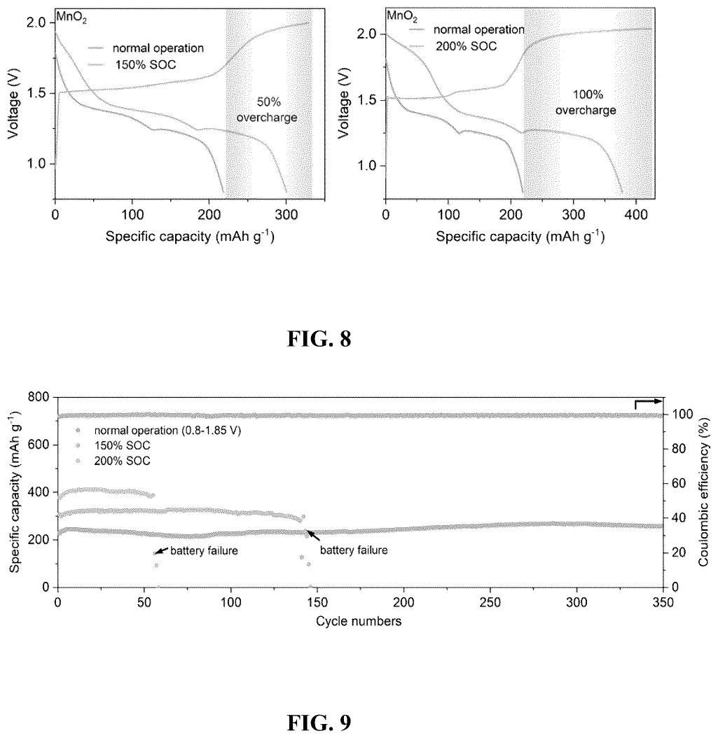

Unlike the Zn∥MnVO battery system, the reversible Mn²⁺/MnO₂ reaction in Zn∥MnO₂ batteries played a significant role in mitigating electrolyte decomposition, as its reaction potential was located at 1.229 V versus the standard hydrogen electrode (vs. SHE), similar to the redox potential of oxygen evolution reaction (OER)¹⁷. As a result, the Zn∥MnO₂ batteries operated at 150% and 200% SOC showed additional discharge plateaus at around 1.9 V in the GCD curves (FIG. 8), with initial CEs of 91.5% and 89.1%, respectively.

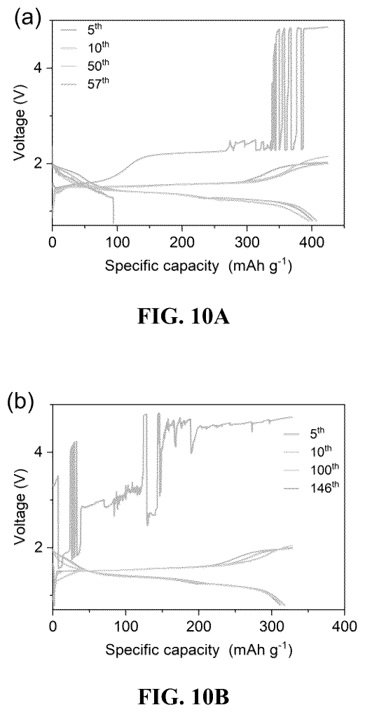

It was noteworthy that the Zn∥MnO₂ batteries demonstrated significantly higher CEs compared to Zn∥MnVO batteries under the same operating conditions, suggesting that the presence of Mn²⁺ in the electrolyte can protect the battery against overcharging to a certain extent. Referring to FIG. 9, the Zn∥MnO₂ batteries exhibited extended lifespans when cycling at overcharge state, which was capable of surviving 143 cycles at 150% SOC and 56 cycles at 200% SOC. However, despite the extended cycle life, voltage fluctuations could still be observed after several cycles (FIGS. 10A-10B), eventually resulting in the failure of the batteries.

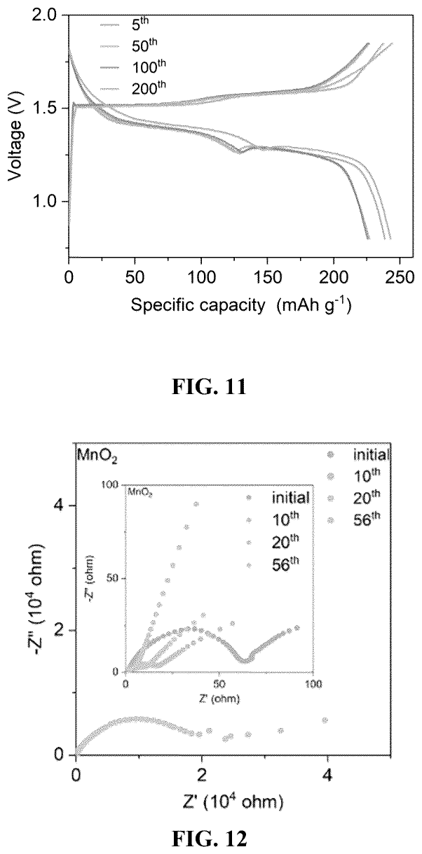

In contrast, as shown in FIG. 11, batteries cycling at normal operation exhibited more stable GCD curves and longer overall lifespans. Moreover, as shown in FIG. 12, the impedance value of the batteries increased to about 2×10⁴Ω after cycling at 200% SOC for 56 cycles, indicating that the accumulated electrolyte decomposition during the cycling process would ultimately lead to the failure of the batteries.

### Example 4

### Gas Generation During Overcharge

At the overcharge state, gas generation stemming from electrolyte decomposition had a detrimental impact on the interfacial contact and charge transfer reactions, which was the primary cause of battery failures. In pursuit of a deeper comprehension of this phenomenon, operando gas pressure measurement was conducted to quantify the gas generation at different charge-discharge states¹⁸.

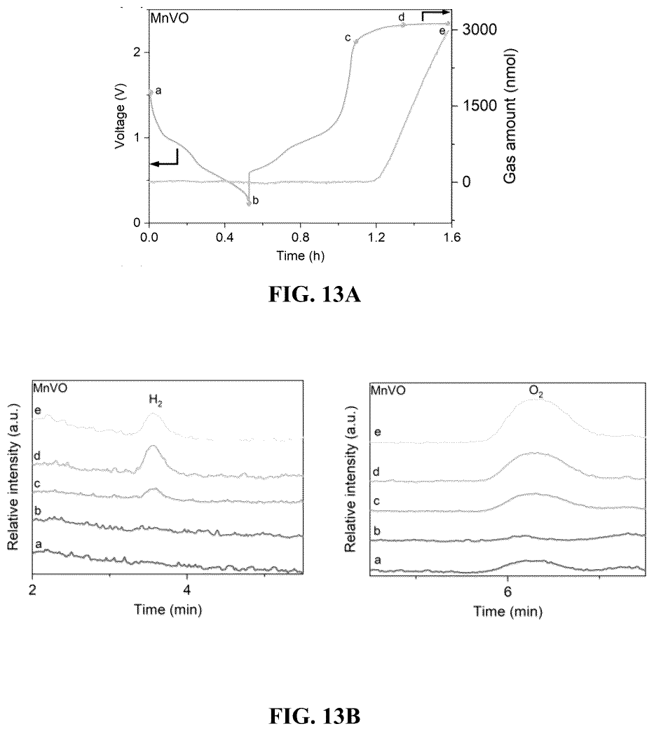

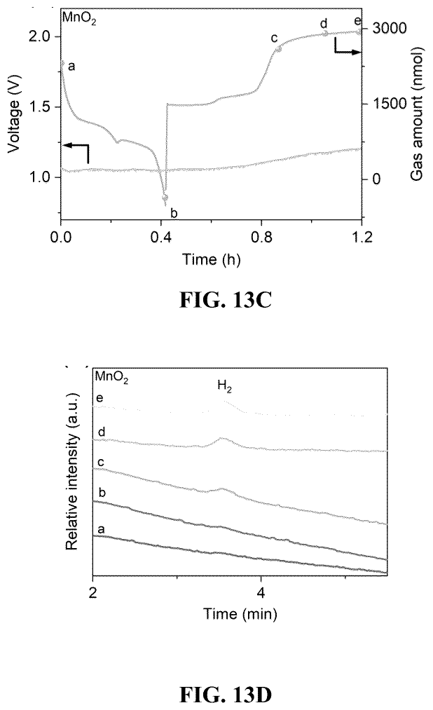

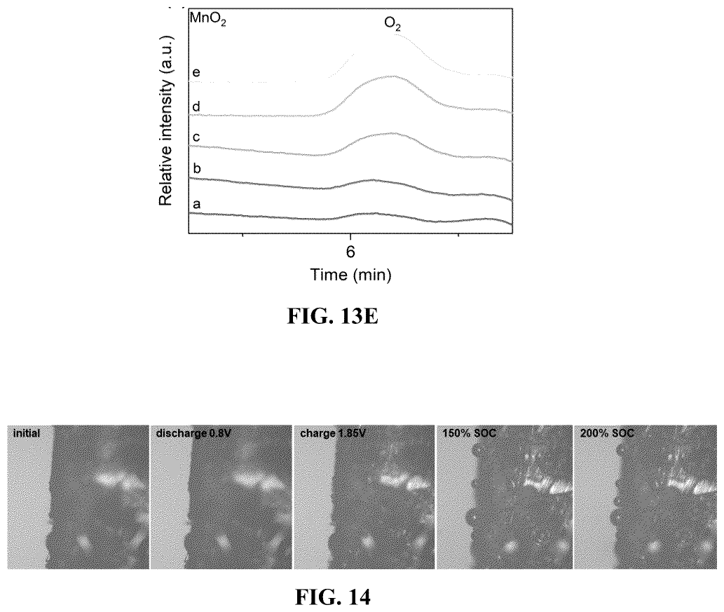

FIG. 13A indicated the consistent gas quantity of the Zn∥MnVO batteries during charging, up until reaching a voltage of 2.0 V. However, a substantial rise in gas generation became evident as the SOC surpasses a certain threshold, exhibiting a pronounced steeper incline in the gas production curve. This observation was corroborated by the in-situ optical microscope images in FIG. 14, which intuitively validated the gas generation behaviors.

The in-situ gas chromatography (GC) further demonstrated that H₂ and O₂ were the primary gases evolved during the overcharge state. As shown in FIG. 13B, almost no signal of H₂ could be detected at the initial state (stage a) and after being discharged to 0.2 V (stage b). However, a considerable amount of H₂ was evolved at 2.0 V (stage c), with its intensity progressively increasing as the SOC rised (stage d) until reaching a stable level (stage e). Similar to H₂, the evolution of O₂ during the charge-discharge process followed a comparable trend, with a minor peak observed during the initial stage, which could be attributed to the presence of O₂ in the surrounding air.

The gas evolution behaviors of Zn∥MnO₂ batteries were also examined utilizing identical methods (FIGS. 13C-13E). The continuous generation of H₂ and O₂ at the overcharged state suggested that the presence of Mn²⁺ in the electrolyte was insufficient to fully suppress water decomposition. However, the decomposition rate was limited by the supplementary Mn²⁺/MnO₂ redox reaction, as evidenced by the more gradual slope of the gas production curve (FIG. 13C).

Additionally, the total amount of gas generated throughout the charge-discharge process was measured to be 620 nmol for Zn∥MnO₂ batteries, significantly lower than the 2983 nmol recorded for Zn∥MnVO batteries. These results validated that the additional Mn²⁺/MnO₂ redox reaction could effectively alleviate the overcharge-related concerns and facilitate improved stability.

### Example 5

### Effect of pH Value During the Overcharge Process

In addition to gas evolution, the fluctuation of the pH value in the electrolyte was investigated to understand the underlying reaction mechanisms involved during the overcharge process.

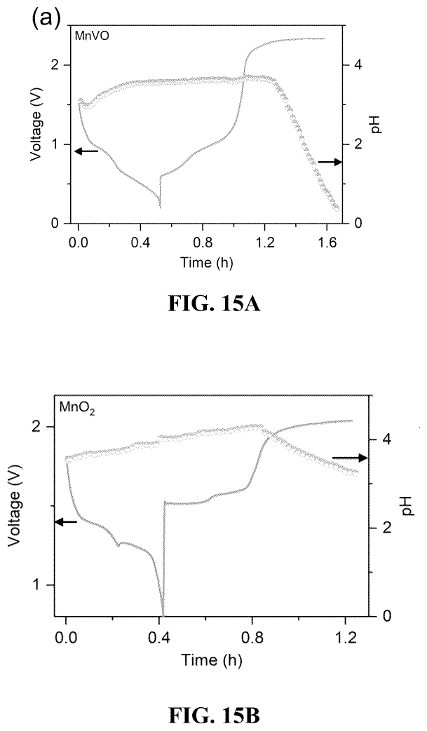

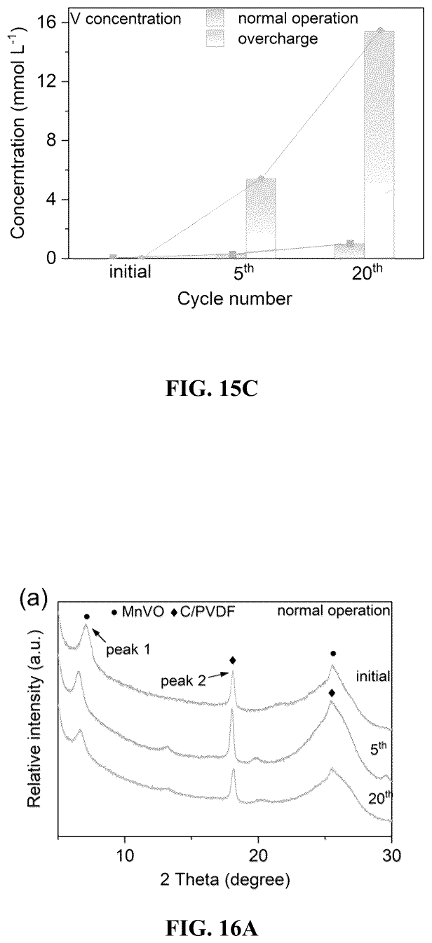

Referring to FIG. 15A, the pH value of the electrolyte in Zn∥MnVO batteries remained stable within the voltage window of 0.2 V-1.6 V, with a slight increase observed during the initial discharge process. This could be attributed to the H⁺ intercalation into the electrode materials and the occurrence of hydrogen evolution reaction (HER) at the anode¹². In contrast, a sharp decrease in pH values could be observed after charging the battery to 2.0V. The decrease in pH values was related to the OER at the overcharged state, leading to the continuous generation of H⁺, succinctly described as follows:¹⁹

6H₂O⇔O₂+4H₃O⁺+4 e⁻(E₀=1.23 V vs. SHE)

Moreover, the elevation in electrolyte acidity could exacerbate the corrosion of Zn anode, thereby leading to an increased generation of H₂¹⁹. The pH variation in Zn∥MnO₂ batteries followed a similar trend, indicating a pronounced OER at the overcharge state. However, the pH value in Zn∥MnO₂ batteries decreased from 4.28 to 2.76 at 200% SOC (FIG. 15B), with a variation significantly smaller than that in Zn∥MnVO batteries (from 3.62 to 0.39). The observed evolution of the pH values in different systems aligned well with the experimental results of the gas amount and GC measurements, further substantiating the influence of the additional Mn²⁺/MnO₂ redox reaction that potentially buffers the changes caused by overcharging.

### Effect of Ion Concentration During the Overcharge Process

Besides the pH variation, the evolution of the ion concentration in the electrolyte after overcharging was also investigated by inductively coupled plasma-optical emission spectroscopy (ICP-OES). FIG. 15C presented the vanadium (V) concentration in the electrolyte of Zn∥MnVO batteries after cycling under different conditions. A trace amount of V (approximately 0.3 mmol L⁻¹) could be observed in the electrolyte after 5 cycles of normal operation. Moreover, the V concentration in the electrolyte exhibited an increasing trend with the number of cycles, indicating the gradual dissolution of the V species into the aqueous electrolyte²⁰. Notably, when cycling at 200% SOC, the V concentration in the electrolyte was significantly higher. After 5 cycles, it rised to 5.44 mmol L⁻¹ and increased to 15.46 mmol L⁻¹ after 20 cycles. This pronounced increase suggested a more severe dissolution of cathode materials, which may be attributed to the higher acidity of the electrolyte at the overcharge state.

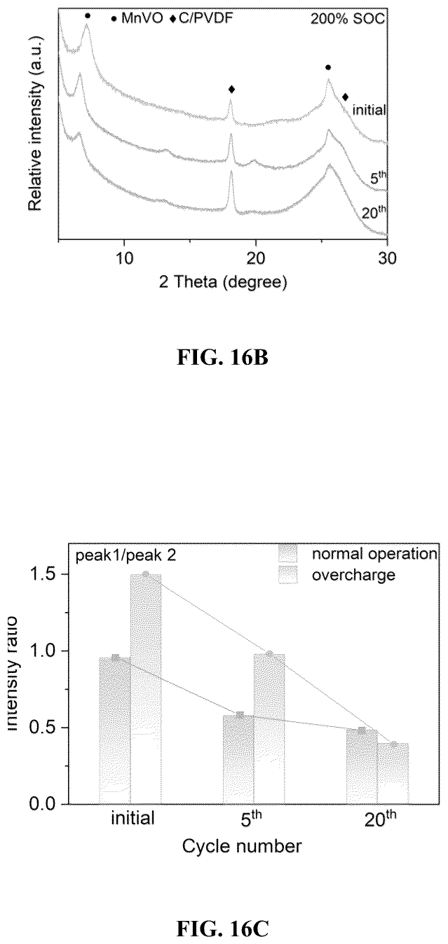

Furthermore, XRD measurements were performed to investigate the cathode materials after cycling at different conditions. As shown in FIGS. 16A-16B, the diffraction peaks corresponding to MnVO were observed in all XRD patterns, indicating the excellent structural stability of MnVO even after cycling at the overcharge state. However, the relative peak intensities assigned to MnVO (peak 1) and the substrate (peak 2) exhibited significant variations among different samples (FIG. 16C). Despite the higher initial intensity ratio for the MnVO electrode cycling at overcharge state (after background deduction), the intensity of peak 1 decreased significantly after 20 cycles. In contrast, the intensity ratio underwent a relatively mitigated change under normal operation. This result provided additional compelling evidence that overcharging of batteries exacerbated the dissolution of MnVO cathode materials.

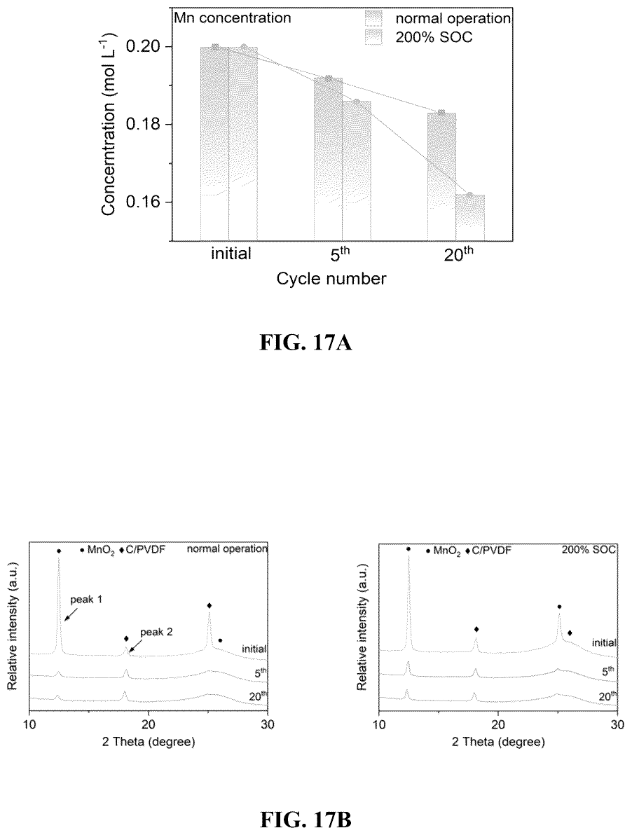

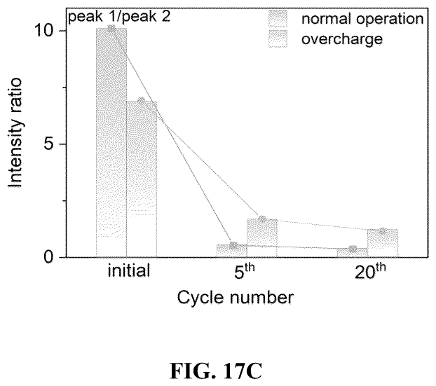

Additionally, an investigation into the evolution of ion concentrations in the electrolyte was conducted for Zn∥MnO₂ batteries, which showed a contrasting trend compared to Zn∥MnVO batteries. Referring to FIG. 17A, the initial Mn concentration in the electrolyte was 0.2 mol L⁻¹, which decreased as the number of cycles increased. The substantial variation in Mn concentration observed in batteries cycling at the overcharged state suggested an intensified deposition of MnO₂ on the cathode surface²¹. XRD analysis indicated that the intensity of MnO₂ diffraction peaks diminished over time, regardless of whether cycling at normal operation or overcharge state, which was attributed to the formation of amorphous structures in the MnO₂ cathode material after cycling (FIG. 17B). However, the MnO₂ cathode cycling at overcharge state exhibited improved crystallinity, as demonstrated by the higher intensity ratio between MnO₂ and the substrate (FIG. 17C), which aligned well with the ICP results indicative of MnO₂ deposition on the cathode surface.

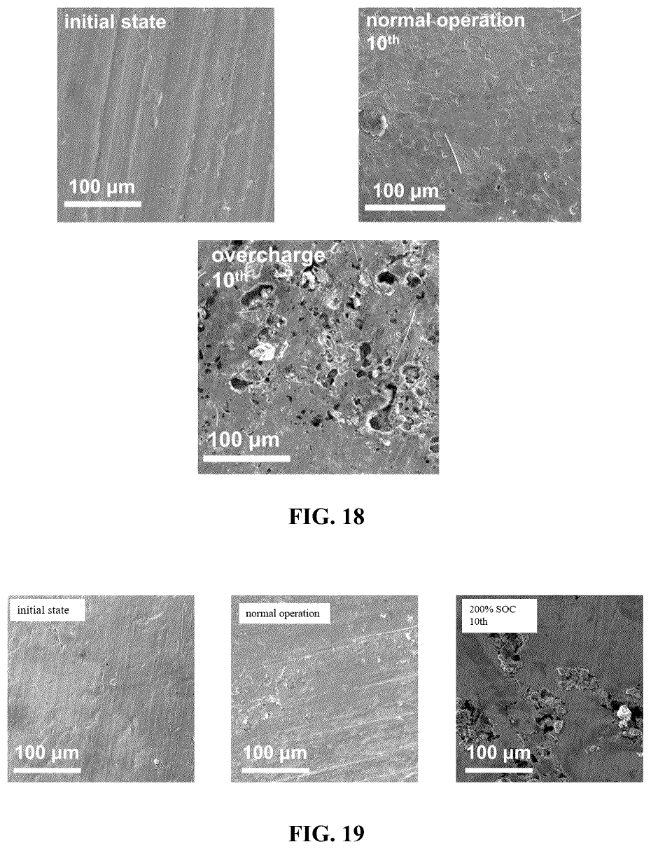

Despite the observed differences in the electrolyte and cathode changed between the two battery systems after overcharging, the anode exhibited similar behavior in both cases. Referring to FIGS. 18-19, negligible morphological changes were observed for the Zn anode cycling under normal operation. However, after cycling at 200% SOC, the scanning electron microscope (SEM) images revealed compelling evidence of dead Zn and numerous irregular holes on the anode surface (FIG. 18). The presence of dead Zn could be attributed to the inhomogeneous deposition of Zn under relatively harsher conditions, while the formation of irregular holes resulted from the corrosion of the Zn anode caused by the increased electrolyte acidity. These morphological changes involving the formation of dead Zn and corrosion reactions may harm the cycling lifespan and CE of ZIBs²².

### Example 6

Interaction of TBA⁺ and BTA⁺ with various Br species

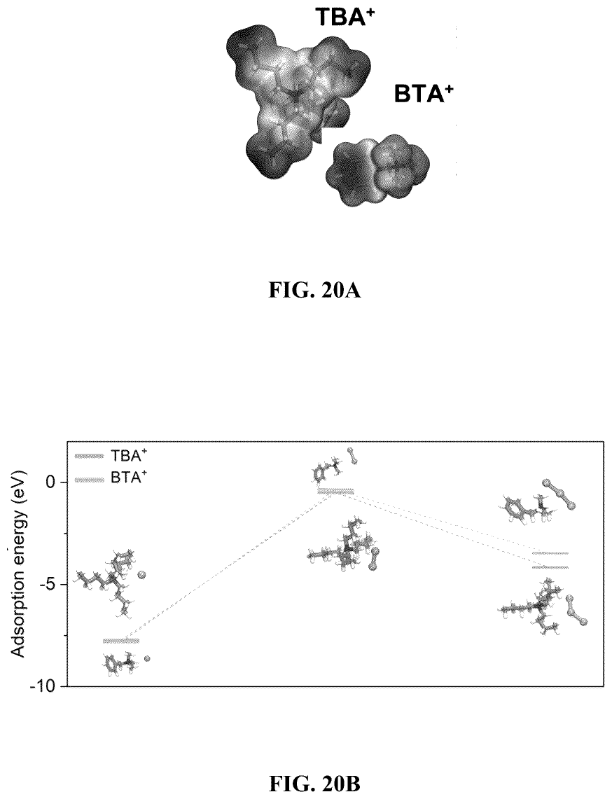

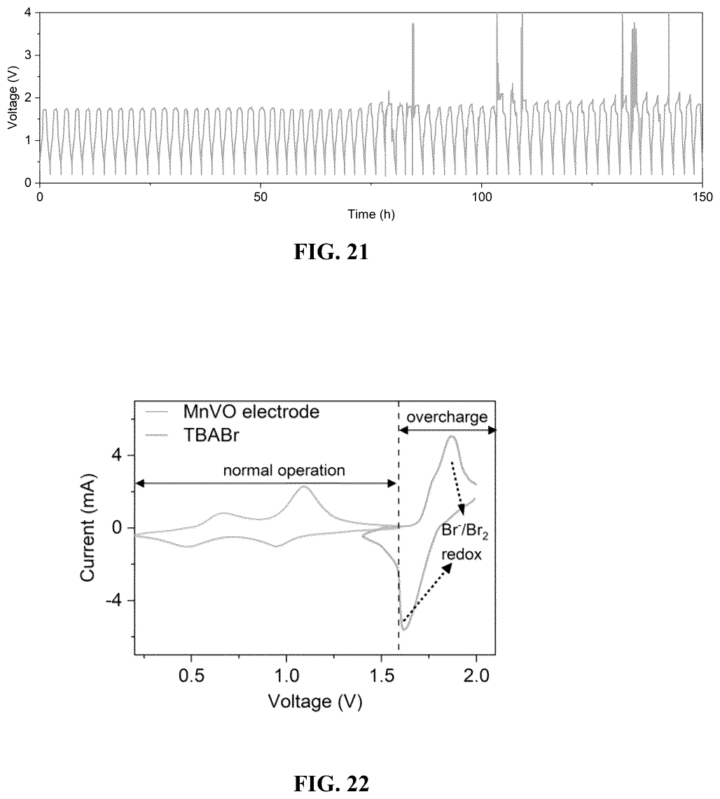

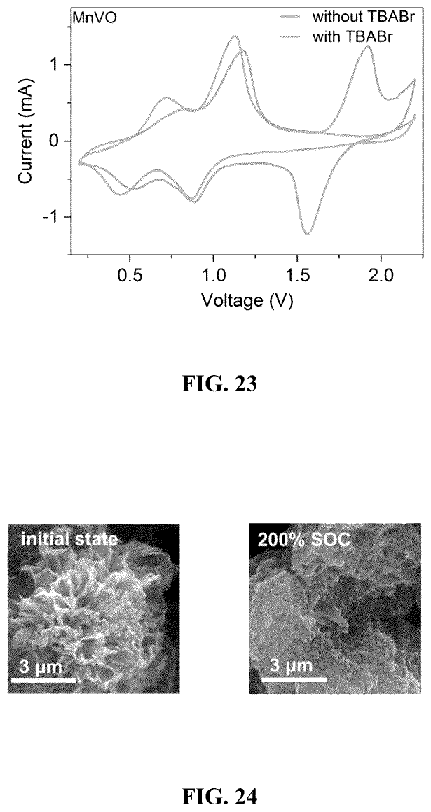

Furthermore, tetrabutylammonium (TBA+) and benzyl trimethylammonium cation (BTA⁺) were utilized as complexing agents to mitigate their oxidizing and corrosive issues associated with Br species^{26, 27}. As shown in FIGS. 20A and 20B, BTA⁺ exhibited higher polarity and weaker interaction with Br₃⁻ and Br₂ than TBA⁺, making the oxidized products (e.g., BTABr₃) more soluble in the polar solvent. As a result, when BTABr was introduced to Zn∥MnVO batteries, it led to large voltage fluctuations during the overcharging process owing to the corrosion of Br species (FIG. 21). In contrast, the introduction of TBABr may contribute to a more stable electrolyte environment. FIG. 22 and FIG. 23 showed that TBABr began to undergo oxidation after the anodic reaction of MnVO was completed, enabling an additional redox couple to protect the batteries from overcharging:

$$2 {Br}^{-} - 2 {e}^{-} ⇔ {Br}_{2} \\ TBABr + 2 {Br}_{2} ⇔ {TBABr}_{3}$$

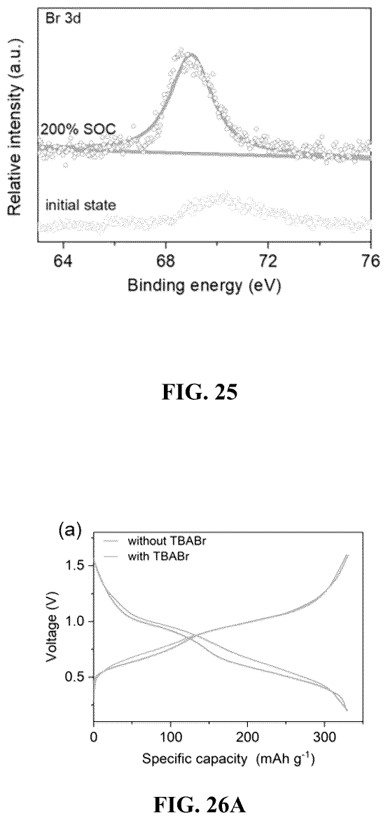

As shown in FIG. 24, the SEM images also revealed the formation of small particles on the surface of the MnVO electrode, indicating the transformation of soluble TBABr to insoluble TBABr₃. Furthermore, the observed increased intensity of the characteristic peak of Br 3d X-ray photoelectron spectroscopy (XPS) analysis compared to the initial state provided compelling evidence of the successful deposition of TBABr₃ on the electrode surface (FIG. 25).

### Reversibility and Stability of Zn∥Mn VO Batteries Offered by TBABr

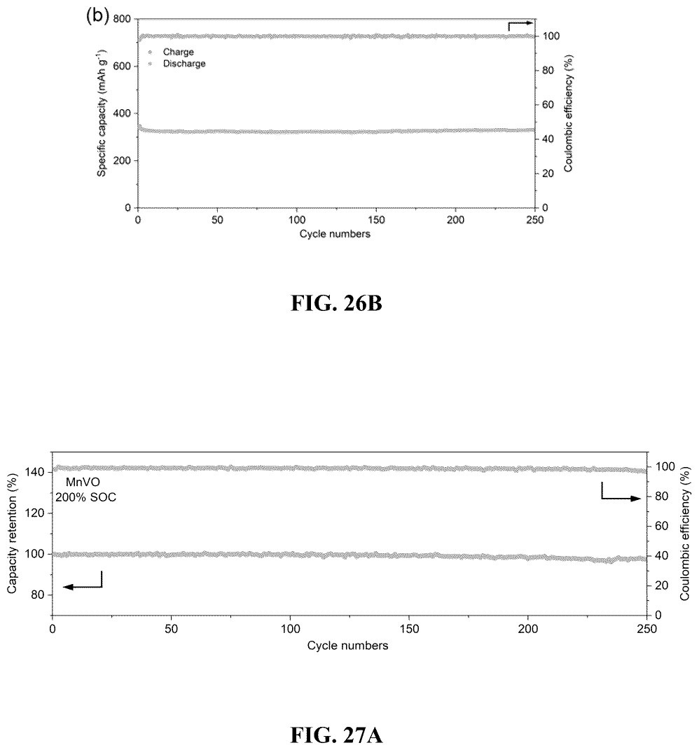

The Zn∥MnVO batteries with TBABr additive showed significantly improved electrochemical performance under various operating conditions. The addition of TBABr had no significant effect on the electrochemical reaction of the batteries under normal operation, as evidenced by the consistent voltage plateaus and stable discharge capacity (FIGS. 26A-26B).

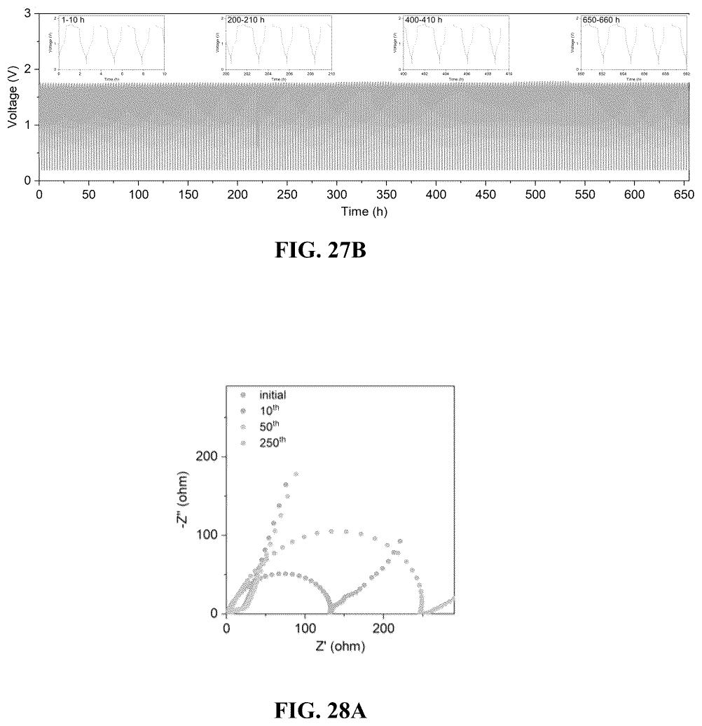

Furthermore, even under the harsh condition of 200% SOC, the Zn∥Mn VO batteries with TBABr still exhibited a prolonged lifespan of 250 cycles with an impressive capacity retention of 98.6% (FIG. 27A). The voltage of the battery remained stable throughout the charge-discharge process without any notable fluctuation, demonstrating the effectiveness of the self-sacrificial additive, TBABr, in protecting the batteries from overcharging for more than 650 hours (FIG. 27B). Notably, this duration significantly surpassed batteries without electrolyte additives, which typically last for only about 50 hours, implying the excellent reversibility and stability offered by TBABr.

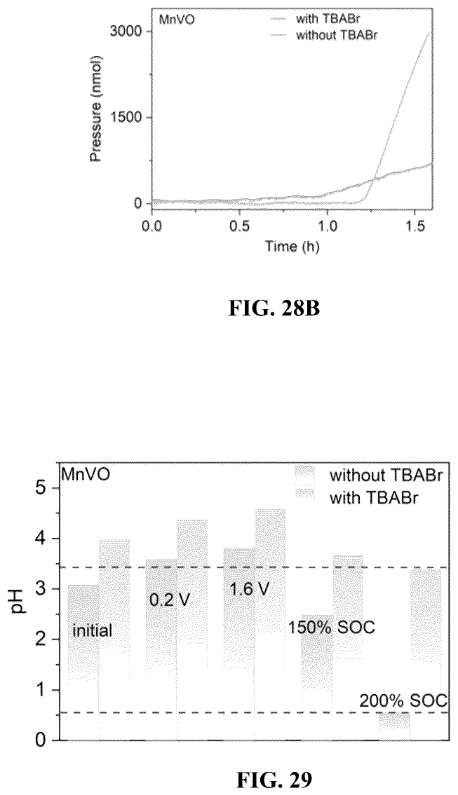

Referring to FIG. 28A, the Zn∥MnVO batteries cycling at 200% SOC exhibited similar impedance levels across different cycles, suggesting stable interfacial contact and charge transfer reactions. Such stability in stable interfacial contact was primarily attributed to the suppressed gas generation and pH evolution facilitated by the additional redox couple. The amount of gas produced during the charge-discharge process was approximately 550 nmol, with only 18% of this amount generated by batteries without the TBABr additive (FIG. 28B). The reduction in gas generation implied the effective mitigation of electrolyte decomposition.

The stability of the electrolyte was further demonstrated by the pH evolution (FIG. 29). The change in the pH value for the electrolyte containing TBABr was considerably smaller than that observed in the electrolyte without the additive, particularly during the overcharge state. Specifically, the pH value of the electrolyte was 3.4 at 200% SOC, which was substantially higher than that of the electrolyte without TBABr (0.39), indicating the provision of a much more stable electrolyte environment due to the presence of the additional redox couple.

Overall, these results demonstrated the advantageous effects of TBABr in suppressing gas generation, mitigating electrolyte decomposition, and maintaining a stable pH in the electrolyte, thereby contributing to the improved performance and enhanced stability of the Zn∥MnVO batteries.

### Reversibility and Stability of Zn∥MnO₂ Batteries Offered by TBABr

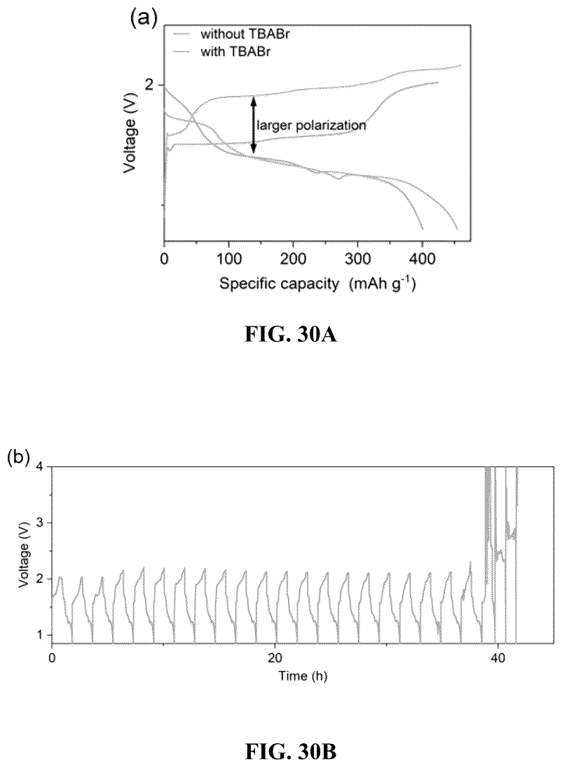

Regarding Zn∥MnO₂ batteries, introducing large-sized TBABr into the electrolyte would cause significant steric hindrance that impedes interfacial reaction, leading to strong polarization and rapid battery failure at the overcharge state (FIGS. 30A-30B) 28. To address this issue, BTABr with a smaller molecular size was introduced as an alternative to offer reversible overcharge protection for Zn∥MnO₂ batteries.

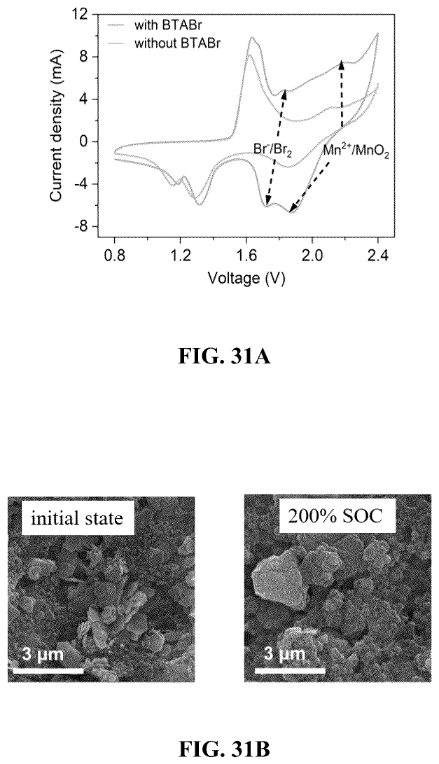

FIG. 31A compared the CV curves of Zn∥MnO₂ batteries with and without the addition of BTABr. The introduction of BTABr resulted in an additional redox peak observed at around 1.8 V, which could be attributed to the reversible Br/Br₂ reaction occurring in the electrolyte. Intriguingly, the CV peak associated with the Mn²⁺/MnO₂ redox couple exhibited a higher current density and a larger area in the presence of BTABr compared to the comparative groups without BTABr, indicating a considerable enhancement in MnO₂ deposition facilitated by the addition of BTABr. Turning to FIGS. 31B, the numerous nanowires growing on the surface of MnO₂ nanosheets indicated the successful deposition of MnO₂ from the electrolyte, implying the potentially enhanced reversibility and stability of batteries facilitated by BTABr.

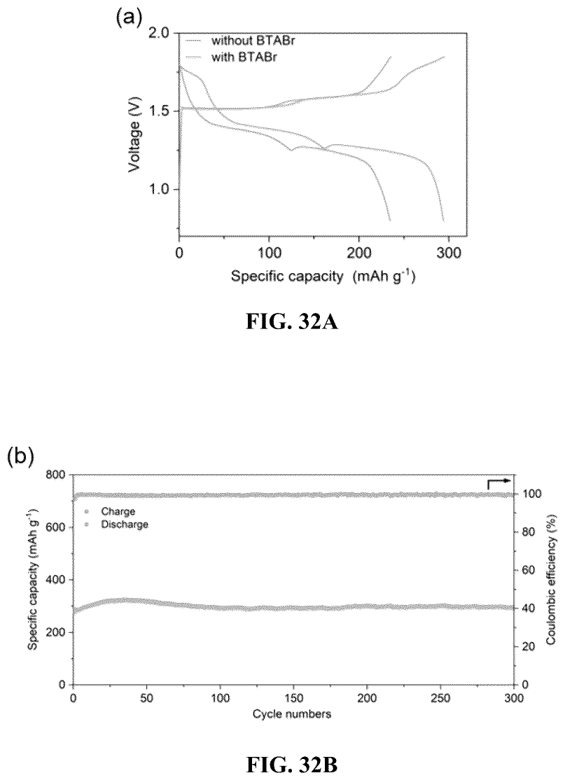

The boosted MnO₂ deposition facilitated by bromine species, consistent with previous reports, could help alleviate the issues arising from overcharging^{29 30}. As shown in FIGS. 32A-32B, a small discharge plateau at approximately 1.75 V could be observed under normal operation, which was attributed to the reversible Br⁻/Br⁰ reaction. This additional reaction contributed to a slightly higher specific capacity of the Zn∥MnO₂ batteries without compromising their cycling stability, resulting in a stable capacity of 293 mAh g⁻¹ after 300 cycles.

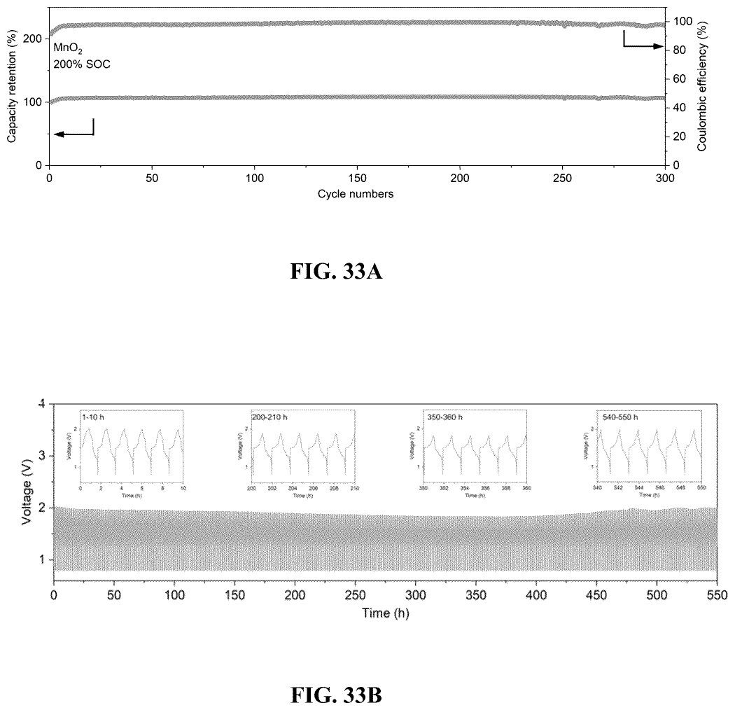

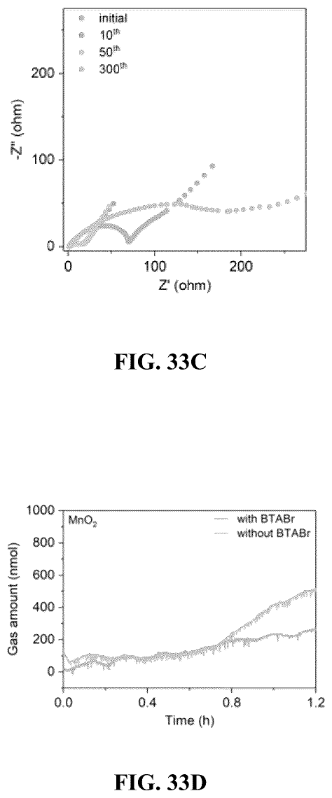

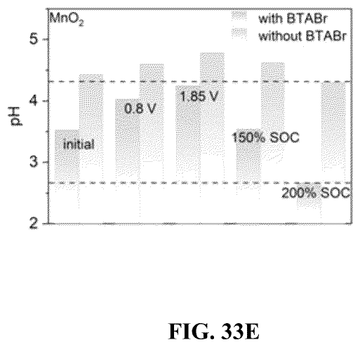

Moreover, the Zn∥MnO₂ batteries cycling at 200% SOC also showed excellent stability, with a capacity retention of 107% after 300 cycles and stable voltage curves throughout the whole charge-discharge process (FIGS. 33A-33B). Incorporating BTABr in the electrolyte could significantly prolong the batteries lifespan to over 500 hours during overcharging, which was considerably longer than the typical lifespan of approximately 90 hours for Zn∥MnO₂ batteries without any additives.

Furthermore, the observed stable EIS impedance, suppressed gas production, and maintained pH values in the presence of the additional redox couple all suggested a more stable electrolyte environment achieved by incorporating BTABr (FIGS. 33C-33E). These findings collectively demonstrated the benefits of incorporating BTABr in enhancing the reversibility, stability, and lifespan of Zn∥MnO₂ batteries, particularly under overcharge conditions.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

### INDUSTRIAL APPLICABILITY

The present invention highlights the effectiveness of redox additives as a promising avenue for bolstering the cycling stability and overcharge resilience of ZIBs.

Aqueous batteries have garnered significant attention as a potential energy storage solution, owing to their safety, cost-effectiveness, and environmental friendliness. The global market size for aqueous sodium-ion batteries reached approximately $252.4 million in 2022, with expectations of substantial growth in the coming years. This expansion is anticipated to be driven by increased emphasis on renewable energy storage, as well as the demand for reliable power sources in portable electronic devices and large-scale energy storage systems.

### REFERENCES

### The Disclosures of the Following References are Incorporated by Reference

ADDIN EN.REFLIST 1. Blanc, L. E.; Kundu, D.; Nazar, L. F., Scientific Challenges for the Implementation of Zn-Ion Batteries. Joule 2020, 4 (4), 771-799.
2. Cao, J.; Zhang, D.; Zhang, X.; Zeng, Z.; Qin, J.; Huang, Y., Strategies of regulating Zn²⁺ solvation structures for dendrite-free and side reaction-suppressed zinc-ion batteries. Energy Environ. Sci. 2022, 15 (2), 499-528.
3. Yang, S.; Guo, X.; Lv, H.; Han, C.; Chen, A.; Tang, Z.; Li, X.; Zhi, C.; Li, H., Rechargeable Iodine Batteries: Fundamentals, Advances, and Perspectives. ACS Nano 2022, 16 (9), 13554-13572.
4. Chen, Z.; Chao, Y.; Li, W.; Wallace, G. G.; Bussell, T.; Ding, J.; Wang, C., Abuse-Tolerant Electrolytes for Lithium-Ion Batteries. Adv. Sci. 2021, 8 (11), 2003694.
5. Belov, D.; Yang, M. H., Failure mechanism of Li-ion battery at overcharge conditions. J. Solid State Electrochem. 2007, 12 (7-8), 885-894.
6. Liang, Y.; Yao, Y., Designing modern aqueous batteries. Nat. Rev. Mater. 2022, 8 (2), 109-122.
7. Rand, D.; Holden, L.; May, G.; Newnham, R.; Peters, K., Valve-regulated lead/acid batteries. J. Power Sources 1996, 59 (1-2), 191-197.
8. Wang, F.; Tseng, J.; Liu, Z.; Zhang, P.; Wang, G.; Chen, G.; Wu, W.; Yu, M.; Wu, Y.; Feng, X., A Stimulus-Responsive Zinc-Iodine Battery with Smart Overcharge Self-Protection Function. Adv. Mater. 2020, 32 (16), e2000287.
9. Wang, D.; Wang, L.; Liang, G.; Li, H.; Liu, Z.; Tang, Z.; Liang, J.; Zhi, C., A Superior delta-MnO₂ Cathode and a Self-Healing Zn-delta-MnO₂ Battery. ACS Nano 2019, 13 (9), 10643-10652.
10. Liu, C.; Neale, Z.; Zheng, J.; Jia, X.; Huang, J.; Yan, M.; Tian, M.; Wang, M.; Yang, J.; Cao, G., Expanded hydrated vanadate for high-performance aqueous zinc-ion batteries. Energy Environ. Sci. 2019, 12 (7), 2273-2285.
11. Song, M.; Tan, H.; Chao, D.; Fan, H. J., Recent Advances in Zn-Ion Batteries. Adv. Funct. Mater. 2018, 28 (41), 1802564.
12. Liu, X.; Euchner, H.; Zarrabeitia, M.; Gao, X.; Elia, G. A.; Groß, A.; Passerini, S., Operando pH Measurements Decipher H⁺/Zn²⁺ Intercalation Chemistry in High-Performance Aqueous Zn/8-V₂O₅ Batteries. ACS Energy Lett. 2020, 5 (9), 2979-2986.
13. Li, Q.; Wang, Y.; Mo, F.; Wang, D.; Liang, G.; Zhao, Y.; Yang, Q.; Huang, Z.; Zhi, C., Calendar Life of Zn Batteries Based on Zn Anode with Zn Powder/Current Collector Structure. Adv. Energy Mater. 2021, 11 (14), 2003931.
14. Ji, W.; Huang, H.; Zhang, X.; Zheng, D.; Ding, T.; Lambert, T. H.; Qu, D., A redox-active organic salt for safer Na-ion batteries. Nano Energy 2020, 72, 104705.
15. Yang, H.; Zhou, W.; Chen, D.; Liu, J.; Yuan, Z.; Lu, M.; Shen, L.; Shulga, V.; Han, W.; Chao, D., The origin of capacity fluctuation and rescue of dead Mn-based Zn-ion batteries: a Mn-based competitive capacity evolution protocol. Energy Environ. Sci. 2022, 15 (3), 1106-1118.
16. Liang, R.; Fu, J.; Deng, Y. P.; Pei, Y.; Zhang, M.; Yu, A.; Chen, Z., Parasitic electrodeposition in Zn—MnO₂ batteries and its suppression for prolonged cyclability. Energy Storage Mater. 2021, 36, 478-484.
17. Chao, D.; Ye, C.; Xie, F.; Zhou, W.; Zhang, Q.; Gu, Q.; Davey, K.; Gu, L.; Qiao, S. Z., Atomic Engineering Catalyzed MnO₂ Electrolysis Kinetics for a Hybrid Aqueous Battery with High Power and Energy Density. Adv Mater 2020, 32 (25), e2001894.
18. Wang, Y.; Liang, B.; Zhu, J.; Li, G.; Li, Q.; Ye, R.; Fan, J.; Zhi, C., Manipulating Electric Double Layer Adsorption for Stable Solid-Electrolyte Interphase in 2.3 Ah Zn-Pouch Cells. Angew. Chem. Int. Ed. 2023, e202302583.
19. Bischoff, C. F.; Fitz, O. S.; Burns, J.; Bauer, M.; Gentischer, H.; Birke, K. P.; Henning, H. M.; Biro, D., Revealing the Local pH Value Changes of Acidic Aqueous Zinc Ion Batteries with a Manganese Dioxide Electrode during Cycling. J. Electrochem. Soc. 2020, 167 (2), 020545.
20. Park, S. K.; Dose, W. M.; Boruah, B. D.; De Volder, M., In Situ and Operando Analyses of Reaction Mechanisms in Vanadium Oxides for Li—, Na—, Zn—, and Mg-Ions Batteries. Adv. Mater. Technol. 2021, 7 (1), 2100799
21. Dai, L.; Wang, Y.; Sun, L.; Ding, Y.; Yao, Y.; Yao, L.; Drewett, N. E.; Zhang, W.; Tang, J.; Zheng, W., Jahn-Teller Distortion Induced Mn²⁺-Rich Cathode Enables Optimal Flexible Aqueous High-Voltage Zn—Mn Batteries. Adv. Sci. 2021, 8 (12), 2004995.
22. Li, Q.; Zhao, Y.; Mo, F.; Wang, D.; Yang, Q.; Huang, Z.; Liang, G.; Chen, A.; Zhi, C., Dendrites issues and advances in Zn anode for aqueous rechargeable Zn-based batteries. EcoMat 2020, 2 (3), e12035.
23. Haregewoin, A. M.; Wotango, A. S.; Hwang, B. J., Electrolyte additives for lithium ion battery electrodes: progress and perspectives. Energy Environ. Sci. 2016, 9 (6), 1955-1988.
24. Ji, W.; Huang, H.; Huang, X.; Zhang, X.; Zheng, D.; Ding, T.; Chen, J.; Lambert, T. H.; Qu, D., A redox-active organic cation for safer high energy density Li-ion batteries. J. Mater. Chem. A 2020, 8 (33), 17156-17162.
25. Li, M.; Li, X.; Qin, G.; Luo, K.; Lu, J.; Li, Y.; Liang, G.; Huang, Z.; Zhou, J.; Hultman, L.; Eklund, P.; Persson, P. O. A.; Du, S.; Chai, Z.; Zhi, C.; Huang, Q., Halogenated Ti (3) C (2) MXenes with Electrochemically Active Terminals for High-Performance Zinc Ion Batteries. ACS Nano 2021, 15 (1), 1077-1085.
26. Li, X.; Li, T.; Xu, P.; Xie, C.; Zhang, Y.; Li, X., A Complexing Agent to Enable a Wide-Temperature Range Bromine-Based Flow Battery for Stationary Energy Storage. Adv. Funct. Mater. 2021, 31 (22), 2100133.
27. Gao, L.; Li, Z.; Zou, Y.; Yin, S.; Peng, P.; Shao, Y.; Liang, X., A High-Performance Aqueous Zinc-Bromine Static Battery. iScience 2020, 23 (8), 101348.
28. Liu, Z.; Li, L.; Qin, L.; Guo, S.; Fang, G.; Luo, Z.; Liang, S., Balanced Interfacial Ion Concentration and Migration Steric Hindrance Promoting High-Efficiency Deposition/Dissolution Battery Chemistry. Adv. Mater. 2022, 34 (40), e2204681.
29. Zheng, X.; Wang, Y.; Xu, Y.; Ahmad, T.; Yuan, Y.; Sun, J.; Luo, R.; Wang, M.; Chuai, M.; Chen, N.; Jiang, T.; Liu, S.; Chen, W., Boosting Electrolytic MnO2-Zn Batteries by a Bromine Mediator. Nano Lett 2021, 21 (20), 8863-8871.
30. Liu, Y.; Xie, C.; Li, X., Bromine Assisted MnO₂ Dissolution Chemistry: Toward a Hybrid Flow Battery with Energy Density of over 300 Wh L⁻¹. Angew. Chem. Int. Ed. 2022, 61 (51), e202213751.
31. ADDIN EN.REFLIST Liu, C.; Neale, Z.; Zheng, J.; Jia, X.; Huang, J.; Yan, M.; Tian, M.; Wang, M.; Yang, J.; Cao, G., Expanded Hydrated Vanadate for High-performance Aqueous Zinc-ion Batteries. Energy Environ. Sci. 2019, 12 (7), 2273-2285.
32. Wang, D.; Wang, L.; Liang, G.; Li, H.; Liu, Z.; Tang, Z.; Liang, J.; Zhi, C., A Superior Delta-MnO₂ Cathode and a Self-Healing Zn-delta-MnO₂ Battery. ACS Nano 2019, 13 (9), 10643-10652.

What is claimed is:

1. An aqueous battery system with stable performance during overcharging, comprising an electrolyte and a self-sacrificial additive, wherein the self-sacrificial additive is incorporated into the electrolyte to provide long-term overcharge protection, and wherein the aqueous battery system demonstrates an enhanced cycling stability even at harsh conditions of 200% state-of-charge (SOC), providing overcharge protection for a duration ranging from 500-700 hours.

2. The aqueous battery system of claim 1, further comprising one or more electrodes, wherein the self-sacrificial additive is impregnated in or coated on the electrodes, the self-sacrificial additive undergoes oxidation before electrolyte decomposition, thereby offering protection against overcharging.

3. The aqueous battery system of claim 2, wherein the one or more electrodes comprise Mn²⁺ expanded hydrated vanadium (MnVO) and manganese dioxide (MnO₂).

4. The aqueous battery system of claim 1, wherein the electrolyte comprises a gel polymer electrolyte, wherein the self-sacrificial additive is incorporated into the gel polymer electrolyte.

5. The aqueous battery system of claim 1, wherein the self-sacrificial additive comprises bromide-based additive in a concentration range of 0.1 M to 2.0 M.

6. The aqueous battery system of claim 5, wherein the bromide-based additive is selected from organic bromides or bromide salts.

7. The aqueous battery system of claim 6, wherein the organic bromides comprise alkyl bromide, brominated ether, brominated esters, and brominated aromatics.

8. The aqueous battery system of claim 6, wherein the bromide salts comprise bromide of alkali or alkaline earth metals.

9. The aqueous battery system of claim 1, further comprising a complexing agent, including tetrabutylammonium (TBA+) and benzyl trimethylammonium cation (BTA+).

10. A method for protecting against overcharge in an aqueous battery system, comprising adding a self-sacrificial additive to the battery system, wherein the self-sacrificial additive reacts during charging to prevent overcharging.

11. The method of claim 10, wherein the self-sacrificial additive is added to an electrolyte in a concentration range effective for overcharge protection.

12. The method of claim 10, wherein the electrolyte comprises a gel polymer electrolyte, wherein the self-sacrificial additive is incorporated into the gel polymer electrolyte.

13. The method of claim 10, wherein the self-sacrificial additive comprises a bromide-based additive, the bromide-based additive undergoes reversible redox reactions during charging and discharging, thereby preventing overcharge-induced degradation.

14. The method of claim 10, further comprising monitoring the battery system's voltage, current, or other relevant parameters to control the charge-discharge process and ensure optimal overcharge protection.

15. The method of claim 10, wherein the concentration of self-sacrificial additive is present in a concentration range of 0.1 M to 2.0 M.

16. The method of claim 10, wherein the self-sacrificial additive is selected from organic bromides or bromide salts.

17. The method of claim 16, wherein the organic bromides comprise alkyl bromide, brominated ether, brominated esters, and brominated aromatics.

18. The aqueous battery system of claim 16, wherein the bromide salts comprise bromide of alkali or alkaline earth metals.
